(19) United States
(12) Patent Application Publication
(10) Pub. No.: US 2013/0343048 A1
(43) Pub. Date: Dec. 26, 2013

(54) Light reflector for a horticultural device

(71) Applicant: Gilles Dumont, St-Philippe de Laprairie (CA)

(72) Inventor: Gilles Dumont, St-Philippe de Laprairie (CA)

(21) Appl. No.: 13/986,764

(22) Filed: Jun. 3, 2013

Related U.S. Application Data
(60) Provisional application No. 61/689,257, filed on Jun. 1, 2012.

(51) Int. Cl. F21V 7/00

(52) U.S. Cl. CPC F21V 7/00
USPC 362/217.07; 362/217.05

(57) ABSTRACT

A reflector arrangement which may be used for a horticultural device, the reflector apparatus comprising a first reflector member extending downwardly from a first point above the light emitting source along a first side thereof, and a second reflector member extending downwardly from a second point above the light emitting source along a second side thereof, each of the reflector members being individually adjustable to increase and decrease the angle with respect to each other to thereby adjust the range of light covered by the light emitting source.

### FIELD OF THE INVENTION

The present invention relates to a reflector arrangement and more particularly, relates to a reflector arrangement which may be used for a horticultural apparatus or device.

### BACKGROUND OF THE INVENTION

The use of artificial lighting during the cultivation of plants is well known and widely practiced. This range is from the individual amateur horticulturist to industries practicing it on a wide scale for growing produce. Conventionally, the plants are grown in a closed building and natural lighting is not sufficient for optimal growth of the plants. Accordingly, different types of artificial lighting have been utilized to provide the necessary lighting. In order to maximize the amount of light received by the plants and to not waste the same, a reflector is normally placed over the top of the lamp to ensure that all of the light output from the lamp or light emitting source is received by the plants.

Reflectors employed in the industry are normally fixedly attached to a frame portion of the structure. While these reflectors function in a desired manner, they may not provide the maximum light output over the desired area. This is particularly the case when the plants receiving the light may grow and/or different plants are utilized.

### SUMMARY OF THE INVENTION

It is an object of the present invention to provide a reflector arrangement for use with a light emitting source in which a reflector arrangement may be adjusted according to the desired use.

According to one aspect of the present invention there is provided a light and reflector comprising a longitudinally extending light emitting source, a reflector arrangement about at least a portion of the light emitting source, the reflector arrangement including a first reflector member extending downwardly from a first point above the light emitting source along a first side of the light emitting source, a second reflector member extending downwardly from a second point above the light emitting source along a second side of the light emitting source, and each of the reflector members being adjustable to increase and decrease the angle with respect to each other to thereby adjust the range of light covered by the light emitting source.

The reflector arrangement, as set forth above, utilizes first and second reflector members which extend from a point above the light emitting source downwardly along respective sides of the light emitting source. The reflector members may be made of any suitable material having the desired reflective properties; conventionally, a metallic material is utilized. However, it would be within the scope of the present invention to utilize reflector members made of other materials such as plastics and the like. In all instances, the reflecting surface of the reflector members is preferably designed to have the highest possible reflective capability.

The reflecting members are preferably individually adjustable so that their position can be maximized for the plant being grown. In some instances, it may be desirable to have the reflective members at different angles depending upon the plant receiving the light. However, it is always possible to provide for the capability of adjusting the reflector members as a pair.

### BRIEF DESCRIPTION OF THE DRAWINGS

Having thus generally described the invention, reference will be made to the accompanying drawings illustrating embodiments thereof, in which:

FIG. 1 is a perspective view of a lamp holder;

FIG. 2 is a view similar to FIG. 1;

FIG. 3 is a side elevational view thereof;

FIG. 4 is a perspective view illustrating the use of reflectors according to an embodiment of the present invention;

FIG. 5 is a side elevational view thereof;

FIG. 6 is an end view illustrating the reflectors in a closed position;

FIG. 7 is a view similar to FIG. 6 illustrating the reflectors in an open position;

FIG. 8 is an end view illustrating a further embodiment of the invention with the reflectors in an open position; and

FIG. 9 is an end view similar to FIG. 8 showing the reflectors in a closed position.

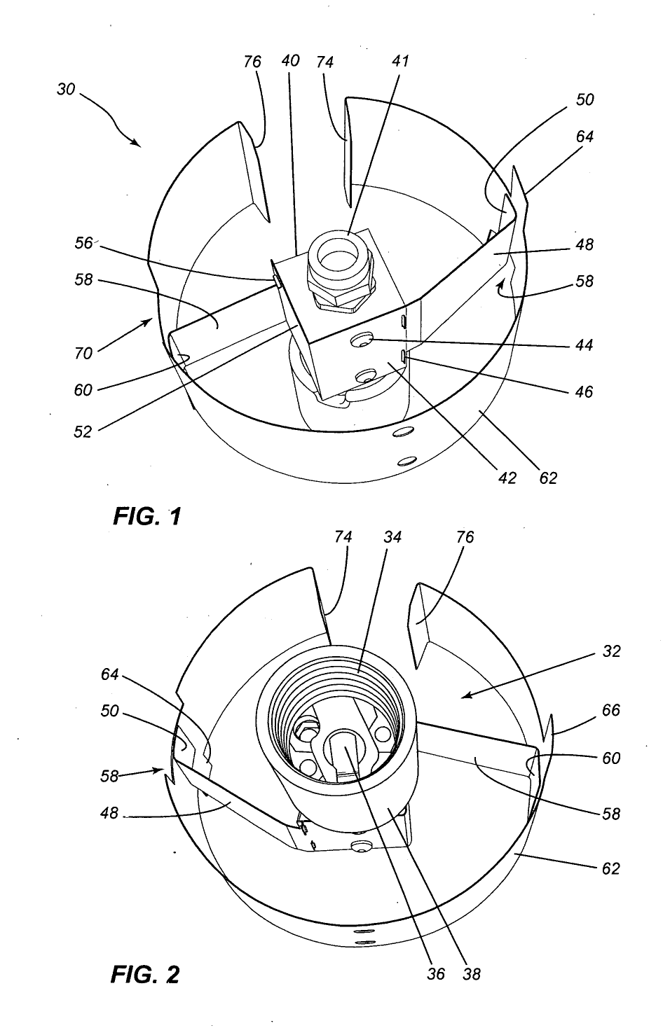

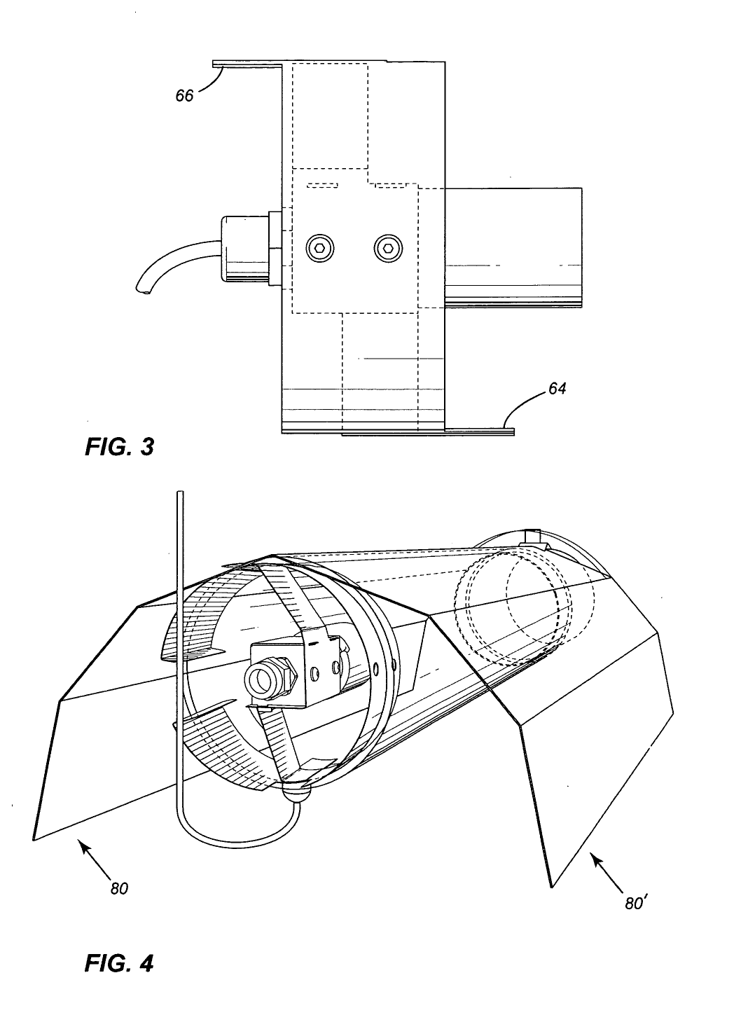

### DETAILED DESCRIPTION OF THE INVENTION

Referring to the drawings in greater detail and by reference characters thereto, there is illustrated a lamp holder which is generally designated by reference numeral 30 and includes conventional socket portion 32 having threads 34 on the interior thereof to receive a threaded bulb. A bottom contact 36 is provided in the base of socket 22 to complete the electrical connection with the bulb (not shown). An outer housing 38 in socket 32 is connected to a lamp base portion generally designated by reference numeral 40. Lamp base portion 40 includes a grommet 41 through which the wires will pass.

A spring device generally designated by reference numeral 43 includes a first wall section 42 secured to lamp base portion 40 by means of screws 44 as well as engagement of tabs 46 from base portion 40. A first arm 48 extends outwardly from the first wall section 42 and forms an acute angle with respect thereto. At the distal end of first arm 48, there is provided a flange 50.

There is also provided a second wall section 52 adjacent to first wall section 42 and which is retained in position by means of screws 54 screw threadedly engaged with lamp base portion 40. As with the first wall section there are provided tabs 56 which engage second wall section 52. A second arm 58 extends outwardly from second wall section 52 at an acute angle with respect thereto and terminates in a flange 60.

Extending substantially about housing 38 and base 40 is a ring 62. Ring 62 is formed of a sheet material and is of a resilient nature. Both first arm 48 and second arm 58 are suitably secured to the inner surface of ring 62 through flanges 50 and 60 by any suitable means such as adhesive, soldering, welding, etc. It will be noted that a stabilizing flange 64 extends outwardly from ring 62 adjacent flange 50 while a second stabilizing flange 66 extends outwardly in an opposite direction to stabilizing flange 64. Stabilizing flange 66 is located proximate flange 60 of second arm 58. It will also be seen that there are provided recesses or cutouts 68, 70 on the opposite sides of stabilizing flanges 64, 66.

As aforementioned, ring 62 is not completely closed at the open ends to thereby provide gripping portions or a handle 74 and 76. Handle 74 and 76 can be gripped to diminish the size of ring member 62 such that it will fit within transparent tube 20 as shown in FIG. 4.

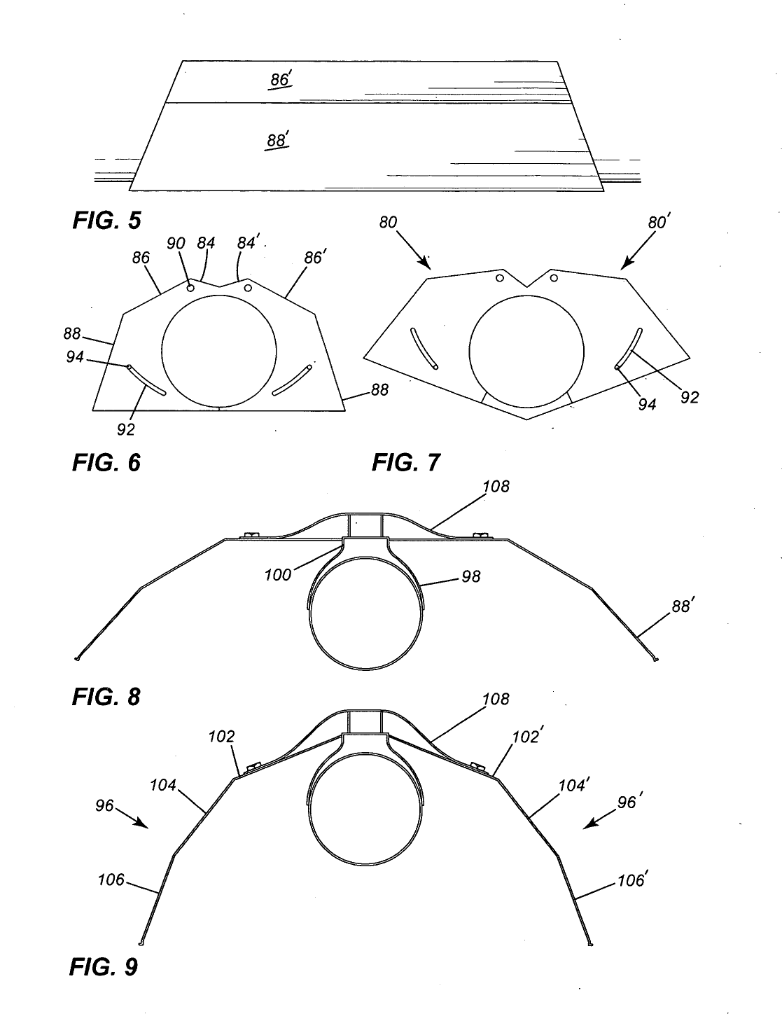

As shown in FIGS. 5 to 9, there is provided an arrangement for reflectors for the lamp or light emitting source. In this regard, the lamp can be of any suitable type conventionally used in horticultural applications. Reflecting arrangement shown in FIGS. 5 to 7, includes a first reflector 80 and a second reflector 80′. As will be seen, first reflector 80 has a first longitudinally extending segment 84, a second longitudinally extending segment 86, and a third longitudinally extending segment 88. Reflector 80 is pivotally connected about pivot point 90 such that it can be moved as shown from a closed position in FIG. 6 to an open position in FIG. 7. A slot 92 and a pin 94 allow for the guided pivotal movement.

In the arrangement of FIGS. 8 and 9, there is provided a lamp 98 supported by a bracket 100. A first reflector 96 is provided on one side and a second reflector 96′ on the other side. Again, first reflector 96 has a first longitudinally extending segment 102, a second longitudinally extending segment 104, and a third longitudinally extending segment 106. A tensioning member 108 functions to exert pressure on reflector 96 such that it may be moved from an open position as seen in FIG. 8 to a more closed position as seen in FIG. 9. This thus directs the light over a smaller area.

It will be understood that the above described embodiment is for purposes of illustration only and that changes and modifications may be made thereto without departing from the spirit and scope of the invention.

I claim:

1. A light and reflector comprising:
a longitudinally extending light emitting source;
a reflector arrangement about at least a portion of said light emitting source, said reflector arrangement including;
a first reflector member extending downwardly from a first point above said light emitting source along a first side of said light emitting source;
a second reflector member extending downwardly from a second point above said light emitting source along a second side of said light emitting source; and
each of said reflector members being adjustable to increase and decrease the angle with respect to each other to thereby adjust the range of light covered by said light emitting source.

2. The arrangement of claim 1 wherein said first and second points above said light emitting source are substantially identical.

3. The arrangement of claim 2 wherein each of said first and second reflector members are individually adjustable.

4. The arrangement of claim 1 wherein each of said first and second reflector members has a concave reflecting surface.

5. The arrangement of claim 4 wherein each of said reflector members comprises a plurality of longitudinally extending flat segments.
